(19) United States
(12) Patent Application Publication
(10) Pub. No.: US 2009/0256443 A1
(43) Pub. Date: Oct. 15, 2009

(54) HOLLOW RING TORUS MAGNET GENERATOR

(76) Inventor: Randal Scott Turner, Granite falls, WA (US)

Correspondence Address: Randal Scott Turner, 3528 Alyson drive, Granite falls, WA, 98252, US

(21) Appl. No.: 12/102,912

(22) Filed: Apr. 15, 2008

(51) Int. Cl. H02K 3/00; H02K 5/132

(52) U.S. Cl. 310/179; 310/87

(57) ABSTRACT

A hollow ring torus permanent magnet generator, with a sphere shaped permanent magnet which spins/revolves within the hollow ring torus passing through insulated copper magnet wire windings which are wound around the exterior portion of the ring torus shaped body which, has two or more coils that said sphere magnet passes through forcing electrons through insulated copper coils which, produces electrical current sufficient to power light emitting diodes or a number of low voltage electrical device. Can be encapsulated within a number of devices i.e., flashlight body, fishing lure body or mounted on the axis of a device i.e., spinning fan blade, tire to produce low voltage as the device spins or moves in a rolling motion allowing the sphere magnet to pass through the insulated copper coil windings.

### BACKGROUND OF THE INVENTION

1. Field of Invention

The present invention relates generally to low voltage permanent magnet electrical generators and more specifically to a hollow ring torus low voltage permanent magnet electrical generator.

2. Related art

It is well known that a high power permanent magnet, can be used in conjunction with insulated copper wire to produce electricity, by passing insulated copper wire through the magnetic field of a permanent magnet continuously leaving and reentering the magnetic field, this motion forces electrons along the copper wire, producing electricity to power low voltage electrical devices such as light emitting diodes or other electrical components that require low voltage.

However the problems with current low voltage permanent magnet generators is that they all incorporate and rely on the use of a center rotating axle with either insulated copper coil windings affixed to the axle which rotates between two permanent magnets;

Or magnets affixed to the axle which rotates past insulated copper coil windings, both of which move independent from one another which requires the generator to have two independent moving parts attached and requiring a bearing on said shaft or similar apparatus.

The problems with a linear motion electric power generator are as an example U.S. Pat. No. 5,818,132 that it can only be activated by movement in a linear motion by shaking side to side or up and down to force the magnet through the coils and therefore making its use limited to that motion. The linear generator will not push the magnet through the coils within a rotating or spinning device to generate low voltage power for light emitting diodes or other low voltage devices because the magnet would remain at one end of the tube while spinning.

The present invention solves the problem sited above of requiring a center axle/shaft that moves independently or the problems sited above with linear motion generators of only being activated by a shaking motion;

By incorporating the use of a spherical ball shaped magnet, which spins/revolves around the inside of a hollow ring torus housing which has insulated copper wire wound around the outer shell potion of said ring torus housing at two or more separate points. This motion forces electrons through said insulated copper coils as said spherical ball magnet spins through said copper coils within said hollow ring torus housing of which copper wire coils wind around. This motion will create enough voltage to power light emitting diodes or other low voltage devices.

### SUMMARY OF THE INVENTION

It is the principle aim of this invention to solve the problem associated with rotary generators that rely on a central shaft, which rotates independent requiring bearings, and exterior-moving components at the end of the shaft to activate the generator or the limits a linear motion generator has with linear motion only to activate the generator.

The present invention solves the problems sited above of requiring a central shaft that moves independently, and the limits a linear generator has.

By using a ball/sphere shaped neodymium magnet spinning inside of a hollow ring torus shaped tube; constantly circling through insulated copper coils when said ring torus is spinning or rolled in a side-to-side motion. The insulated copper wire that is wound around said hollow ring torus would form coils at two or more points. These allow the sphere magnet to forces electrons through said copper coils/wires as the magnetic field from the spinning ball magnet passes through said copper coils: creating electricity to power said light emitting diodes or other devices that require low voltage. Broadly, the hollow ring torus magnet generator assembly comprises:

A first portion consisting: a hollow ring torus shaped housing of non-magnetic durable material (e.g., plastic, aluminum, hardened rubber) a hollow cavity within, that encapsulates a round/sphere shaped neodymium permanent magnet, which rolls around the inner hollow torus tube, continuously circling through insulated copper wire windings, which wind around the outer portion of said hollow torus tube, and connected to light emitting diodes, or devices which requires low voltage to activate.

These and other features and advantages of the present invention will be more fully understood from the following detailed description with reference to the accompanying drawings.

### BRIEF DESCRIPTION OF DRAWINGS

FIG. 1 is a perspective view of a hollow ring torus permanent magnet generator assembly in accordance with the present invention;

FIG. 2 is a perspective exploded view of the hollow ring torus permanent magnet generator assembly of FIG. 1, showing the manner in which this is assembled thereof in greater detail;

FIG. 3 is a top-sectioned view of the hollow ring torus permanent magnet generator assembly in accordance with the present invention showing the internal components thereof in greater detail;

FIG. 4 is a side view of the hollow ring torus permanent magnet generator assembly in accordance with the present invention;

FIG. 5 is a side sectioned perspective view of the present invention showing the internal chamber in better detail.

FIG. 6 is a top-sectioned perspective view of the present invention showing the sectioned hollow torus shaped inner chamber in better detail.

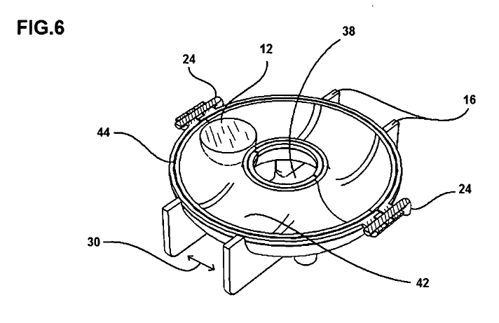

### DETAILED DESCRIPTION

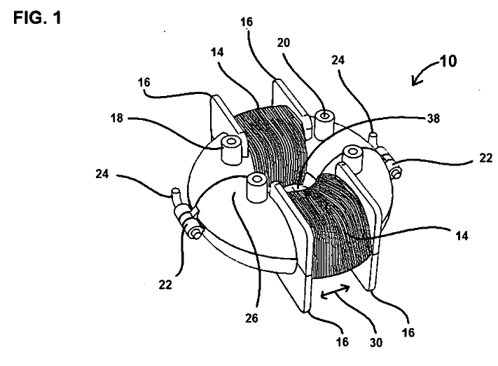

FIG.1 shows a hollow ring torus generator assemble 10 in accordance with the present invention.

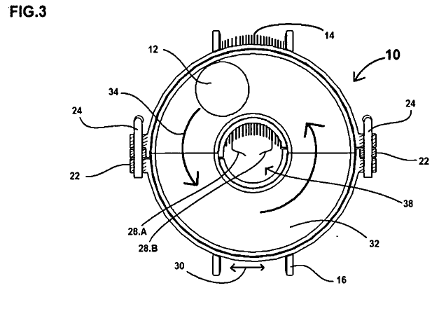

As will be described below, the generator is made up of four principal assemblies 10.a 10.b 10.c 10.d that form a hollow torus/doughnut shape with a center hole 38, two insulated copper coil windings 14, the insulated copper wire is wound around channels 30, to fill the space between two walls 16, said copper wire winding has two ends 28.A 28.B (see FIG. 3) of which remain exposed after winding to allow for attaching to a low voltage electrical devices which can be attached by means of mounting posts 18, and fastened by screws which screw into holes 20, and are tightened to secure the device.

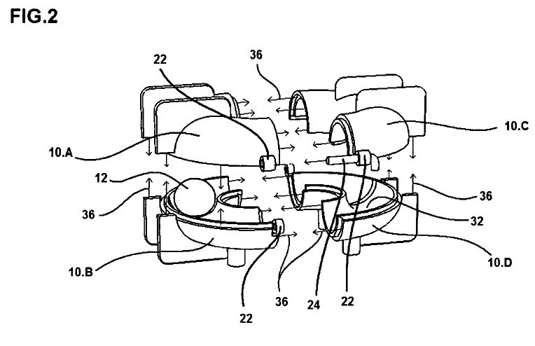

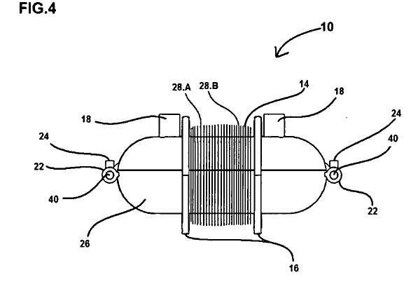

As can be seen more clearly in FIG. 2, the four principle assemblies 10.A 10.B 10.C 10.D are mounted to one another in the directions illustrated by arrows 36, the connections between the parts are fastened by locking pins 24, through holes 40, (see FIG. 4) before the locking pins are inserted, parts 10.A and 10B would be connected together and slid into channels 44, after which insulated copper wire 14, is wound around channel 30, to fill the space between side walls 16, then taped into place with two ends 28.A 28.B (see FIG. 3) which are left assessable for connecting to a low voltage electrical device.

The assembly method above, is used for parts 10.C and 10.D, after which a sphere shaped neodymium permanent magnet 12, is placed into the internal hollow torus chambers 32, and then parts 10.A and 10.B along with 10.C and 10.D are connected together then fastened by pins 24, through holes 22, however, it will be understood that other forms of connections may be used, screws, clamps for example.

FIG. 4, The mounting posts 18, allow for adding a mounting plate on the generators top portion that could have with light emitting diodes or other electrical devices attached therein which can be screwed into holes 20, and fasted to the generator body.

The sphere shaped neodymium magnet rolls inside of the hollow torus tube shaped chamber 32, in a circular direction 34, passing through two insulated copper wound coils 14, which in turn forces electrons through said copper wire creating electrical current to a low voltage electrical device mounted to said generator.

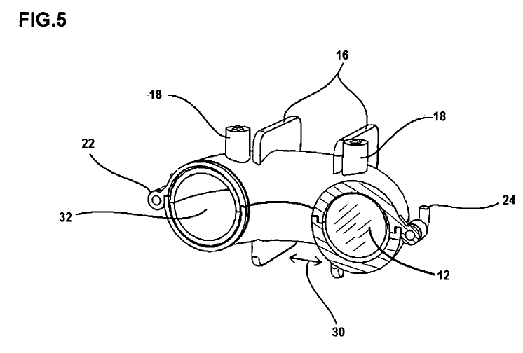

The hollow torus inner tube 32, has a contoured outer shell 26, (see FIG. 1) which is a ring torus 42, as can be seen in greater detail in FIG. 5, allowing the sphere magnet 12, which is slightly smaller in diameter then said hollow torus inner tube 32, allowing it to roll continuously and freely inside of the tube 32, passing through insulated copper coils 14, when the generator body 10, is spinning or rolling in a side to side motion to generate electricity.

It is to be recognized that various alterations, modifications, and/or additions may be introduced into the constructions and arrangements of parts described above without departing from the spirit or ambit of the present invention as defined by the appended claims.

What is claimed is:

1. A hollow ring torus permanent magnet generator assembly comprising:
Four main body assembled parts that form a hollow ring torus shaped housing of a non magnetic durable material, (e.g., plastic, aluminum) having a hole within its center and of which has a hollowed inner core/chamber running through the length of said ring torus shaped body;
With two or more second assembled part consisting of insulated copper magnet wires wound around the outer shell of the ring torus forming coils on two or more area's around the tube;
A third assembled sphere shaped neodymium permanent magnet, which rolls/revolves within said hollow ring torus chamber in a circular motion when said generator spins or is rolled in a side-to-side manner forcing electrons through the copper wire to supply electrical current to a low voltage electrical device.

2. The generator assembly of claim 1, wherein:
The insulated copper wire is wound around the exterior on two or more sides to form copper coils around the hollow ring torus shaped tube and of which ample wire is left remaining visible on both ends of each copper coil after winding which is for attaching to capacitor, rechargeable battery, light emitting diodes or any low voltage electrical devices.

3. The generator assembly of claim 2, further comprising:
Four mounting posts with holes for attaching a low voltage device such as a light emitting diode socket plate or other apparatus to screw into said mounting holes allowing the copper insulated wire to attach firmly to a low voltage device.

4. The generator assembly of claim 1, wherein:
All parts other then the magnet are made of non-magnetic materials so they do not interfere with the sphere magnet while revolving within the hollow torus tube.

5. The generator of claim 1, wherein:
The neodymium magnetic sphere of claim 1, moves freely within the hollow ring torus chamber with a minimum of space between the sphere magnet and copper coil allowing the magnetic field to pass as close to the copper coil as possible while passing through each coil without obstructing the magnets movement within said hollow ring torus.

6. The generator of claim 1, wherein:
The generator assembly could include a capacitor or rechargeable battery for storing the electrical charge.

7. The generator of claim 1, wherein;
The generator assembly could further include means for hermetically sealing the generator housing within a number of embodiments for use in water and of which would protect said generator housing from damage.

8. The generator of claim 7, wherein;
The generator can be activated by spinning while attached to the outside of or encapsulated within a spinning device or rolling device that allows the magnet ball to roll around the inside of the hollowed ring torus tube.
